(19) United States
(12) Patent Application Publication
(10) Pub. No.: US 2009/0150170 A1
(43) Pub. Date: Jun. 11, 2009

(54) Method and apparatus for fraud reduction and product recovery

(75) Inventors: Peter J. Junger, Redmond, WA (US); Kristin Secreto, Kirkland, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America, Redmond, WA (US)

(21) Appl. No.: 12/314,150

(22) Filed: Dec. 4, 2008

Related U.S. Application Data
(60) Provisional application No. 60/996,932, filed on Dec. 11, 2007.

(51) Int. Cl. G06Q 99/00

(52) U.S. Cl. 705/1

(57) ABSTRACT

Certain exemplary embodiments relate to techniques for fraud reduction and/or product recovery. For example, in certain exemplary embodiments, a database includes a plurality of product entries, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. Product checking programmed logic circuitry is configured to determine whether the product to be checked was legitimately acquired. The second interface is further configured to provide an indication to the second authorized user whether the product was legitimately acquired.

### CROSS-REFERENCE TO RELATED APPLICATION

This application claims the benefit of U.S. Application Ser. No. 60/996,932, filed on Dec. 11, 2007, the entire contents of which is hereby incorporated herein by reference.

### TECHNICAL FIELD

The technology herein relates to fraud prevention and recovery. More particularly, the technology herein relates to fraud prevention and recovery using an electronic system for registering product transactions. Even more particularly, the technology herein relates to fraud prevention and recovery using an electronic registration system accessible by fraud prevention and recovery agencies.

### BACKGROUND AND SUMMARY

Federal law enforcement authorities estimate as much as $30 billion in merchandise is stolen annually by theft rings. According to the National Retail Federation, in 2006 retailers lost $9.6 billion due to fraudulent returns alone. The most popular store-return fraud, according to the National Retail Federation, is the return of stolen merchandise. Merchandise returned that was originally purchased with fraudulent or counterfeit tender ranks second, followed by returns using counterfeit receipts. The multibillion-dollar problem impacts not only retailers and corporations, but also everyday consumers.

Credit cards, checks, gift cards, etc., when stolen or counterfeited using identity theft techniques, are used soon after to buy merchandise or new gift cards before a person can report the theft. These purchases are then liquidated and converted in to cash or store credit. Store credit can then be used to make “legitimate” purchases.

Some exemplary methods used to liquidate merchandise are on-line auction houses such as eBay, CraigsList and pawn shops. Merchandise is also sold privately, sold to unsuspecting or corrupt retailers/mom-and-pop shops, or is fraudulently returned back to a store (often the same store from which the merchandise was stolen) for cash refunds or in-store credit.

Currently, products obtained via fraudulent sales transactions and through theft cannot be traced to the original store transaction or to the fraudulent tender used in the sales transaction. Thus, even if the product is recovered, it cannot be positively linked to a particular store and/or to a specific sales transaction.

Retail/store inventory theft is a sizable and a growing problem in the U.S. Dishonest employees, customers, and criminal gangs steal many of these items for the purpose of returning them back to the store for cash or in-store credit.

Retailers/stores are faced with a challenging and expensive task and face tradeoffs with securing/protecting their assets while trying to openly display merchandise, which has proven to increase sales. Retailers resort to locking valuable items behind secured glass, attaching security source tags to the packaging, installing video surveillance equipment and employing other security devices, many of which are expensive and detract from sales. Although these security devices/steps do help deter theft, often they are circumvented by criminals who remove items from the packaging, grab several items and running through the store exit door, use duplicate/counterfeit receipts, or use found receipts. Criminals have also been known to use legitimate receipts to steal items similar to the one on the receipt and fool 2 store greeters and/or security guards when the greeter/guard verifies purchases at the store exit, etc.

Items involving receipts/counterfeit receipts may never even physically leave the store. Criminals simply remove the item from a store's shelf and take it directly to the store's customer service/returns desk for a cash refund or an in-store-credit.

Another challenge faced by retailers is proving to law enforcement that they have ownership of recovered stolen items. If items are stolen off of a truck before they ever make it to a retailer, the item may have no tag or other association with the retailer affixed thereto. If the item is subsequently recovered by the police, it is difficult, if not impossible, for a particular retailer to prove that the item belongs to them.

The exemplary illustrative non-limiting implementations provide an electronic registration system that enables individual product identification information to be gathered at the point of a transaction. This information may be added to one or more transaction databases as a record associated with that transaction. For example, if a credit card, check card, gift card, etc. is stolen and a purchase transaction is determined, after-the-fact, to have been fraudulent based on the use of the stolen card, the record associated with the fraudulent sales transaction may be flagged in the central database. The central database may also be updated, for example, with the nature of the fraud committed and the contact information of the party reporting the fraud. According to this exemplary illustrative non-limiting implementation, credit-card companies, retailers, insurance companies, law enforcement, retail asset protection investigators, etc., can make use of this reporting aspect.

Methods and techniques for point-of-sale (POS) registration of goods are taught in U.S. Pat. No. 5,978,774, the contents of which are incorporated herein by reference. In an exemplary environment, individual product identification information (such as a serial number) is stored in a local transaction database, along with additional information, such as the date of the transaction. A transaction receipt, such as a customer sales receipt, is created and may include the individual product identification information and the date of the transaction. Additionally, the individual product identification information and the transaction date may be communicated to a separate location for inclusion in a general transaction database. The local transaction database may include, for example, sales made by a particular store or sales made by several affiliated stores and is not necessarily co-located with the point of sale.

Where a serial number is used to identify the individual product, one or more check digits may be used in conjunction with the serial number. In this way, the validity of the serial number may be verified and, if it is invalid, a system operator may be prompted to re-enter the serial number. The serial number may be scanned, entered with a keypad, or input with any other suitable technique. Other suitable methods for validating the serial number are also contemplated.

Prior to obtaining individual product identification information, the electronic registration system may identify the type of product by evaluating, for example, the product SKU number derived from a universal product code (UPC) or electronic product code (EPC). In one exemplary implementation, the individual product identification information is obtained only if the product is of a type for which electronic registration is desired.

The point of transaction information, including information such as the individual product identification information and the transaction date, may be communicated for use in a general database in a number of different ways. For instance, an electronic link to the location of the general database may be established or information may be recorded and physically transferred to that location. The communications may occur periodically, on an item-by-item basis, or otherwise.

In one exemplary illustrative non-limiting implementation, all of the information stored with any given ID is product, not customer related. That is, for any given purchase, while a unique item ID, date of purchase, price of purchase, place of purchase, etc., may be stored, all the information is product, not person, oriented. This ensures that a certain level of security and customer privacy is associated with the database of this exemplary implementation. If the database is hacked or otherwise wrongfully accessed, no customer information can be had. At the same time, a customer can identify a product within the database through one or more of the identifiers.

If, for example, a TV is stolen, and the customer knows when, where, the brand name, and how much they paid for it, the unique ID can be retrieved and that item can be flagged as stolen, without the customer having to give any personal information up for storage in the database. Of course, personal information can be stored if desired, and if a product is stolen, a customer may request that some personal contact information (e.g., a non-descriptive email address such as xyz123@hotmail.com) be associated with that product in the event that it is recovered.

According to another exemplary illustrative non-limiting implementation, in order to track what merchandise should be on the shelves at a given time, items may be registered with a database upon shipment to a retailer, receipt by a retailer, or at some other suitable time. If those items are again subsequently registered when sold, then it can easily be determined if an item that is being returned is one that was sold legitimately, sold in connection with a fraudulent transaction, or not sold at all.

In this exemplary implementation, if the serial number of the product is scanned when returned, the retailer can quickly see the record associated with that unique registration number and determine whether a refund/credit should be given or whether the authorities should be contacted. Such a determination can even be done automatically. Since the database may be referenced at the point of the transaction, as opposed to a later time, the store security could be contacted as soon as the fraud was discovered. Of course, these suspect transactions may be accessed in batch and investigated later.

In a further exemplary illustrative non-limiting implementation, if an open empty package is discovered in a store, the package is scanned and the item is identified as lost/stolen. If later the item is found, re-packaged, and legitimately sold, then the item registration at point of sale overrides the lost/stolen status. Alternatively, if someone tries to return the item, the database will show that this item was never purchased. This can be useful in preventing people from opening a package in a store and attempting to return without the packaging while still inside the store, which is a common practice used to circumvent the security source tag (oftentimes provided by Sensormatic, Checkpoint, or another company) usually affixed to the packaging and not the product itself.

According to yet another exemplary illustrative non-limiting implementation, consumers can also utilize the database to register personal items. If those items are lost or stolen, then registrations, based on, for example, serial numbers, can be accessed and a flag of “lost” or “stolen” can be added. If the goods are recovered or turn up, say, in a pawn shop, law enforcement officials or the pawn shop owner can check the database to determine the status of the goods and to whom they belong, and/or contact the rightful owner, e.g., via a previously provided anonymous email address (e.g., xyz123@hotmail.com).

Numerous parties will find such a fraud prevention/recovery system useful. A non-exhaustive exemplary list includes: retailers, law enforcement, courts, pawn shops, online auction houses, individuals, etc. In one exemplary illustrative non-limiting implementation, anyone with a pre-approved pass-code can access the database. Access can be had using, for example, the Internet, a computerized register, a telephone, wireless devices operable to connect to the database, etc.

Another exemplary illustrative non-limiting application of the crime prevention database (CPD) to verify that a particular product belongs to a particular retailer. Since retailers generally receive products in blocks with serial numbers in numeric order, the CPD can be used to verify which surrounding serial numbers were purchased/sold by a retailer. If it can be proven that all serial numbers surrounding the serial number of a recovered item correspond to a certain retailer, it is likely that the stolen item belongs to that particular retailer.

In certain exemplary embodiments a fraud reduction and product recovery system is provided. A database includes a plurality of product entries, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. Product checking programmed logic circuitry is configured to determine whether the product to be checked was legitimately acquired. The second interface is further configured to provide an indication to the second authorized user whether the product was legitimately acquired.

In certain exemplary embodiments, in a fraud reduction and product recovery system, a method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

In certain exemplary embodiments, a computer-readable storage medium tangibly storing instructions for causing a computer to implement a fraud reduction and product recovery method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

Programmed logic circuitry may include, for example, any suitable combination of hardware, software, firmware, and/or the like. A computer-readable storage medium may include, for example, a disk, CD-ROM, hard drive, and/or the like.

The exemplary embodiments, aspect, and advantages described herein may be used in any suitable combination or sub-combination such that it is possible to obtain yet further embodiments of the instant invention.

### BRIEF DESCRIPTION OF THE DRAWINGS

Aspects and characteristics of the exemplary illustrative non-limiting implementations will become apparent from the following detailed description of exemplary implementations, when read in view of the accompanying drawings, in which:

FIG. 1 is an exemplary schematic block diagram illustrating an example of an overall exemplary electronic registration system;

FIG. 2 is an exemplary flowchart illustrating a series of steps that may be performed at a point of sale for registering a product transaction;

FIG. 3 illustrates an exemplary transaction receipt which reflects a product serial number and a transaction date;

FIG. 4 illustrates an exemplary flow chart for an electronic data interface between a product retailer and a product manufacturer;

FIG. 5 is an exemplary block diagram of an exemplary database system;

FIG. 6 illustrates an exemplary flow chart for product registration before the product is placed into commerce;

FIG. 7 illustrates an exemplary flow chart for a product status update when a product is stolen, sold, discovered missing, etc.;

FIG. 8A illustrates an exemplary flow chart for a product check;

FIG. 8B shows an exemplary process for notifying asset protection under the exemplary system shown in FIG. 8A; and

FIG. 9 shows an exemplary process for verifying ownership of a recovered item based on serial number clustering.

### DETAILED DESCRIPTION

It will be recognized by those of ordinary skill that modification, extensions and changes to the disclosed exemplary implementations may be made without departing from the scope and spirit of the invention. In short, the present invention is not limited to the particular forms disclosed herein.

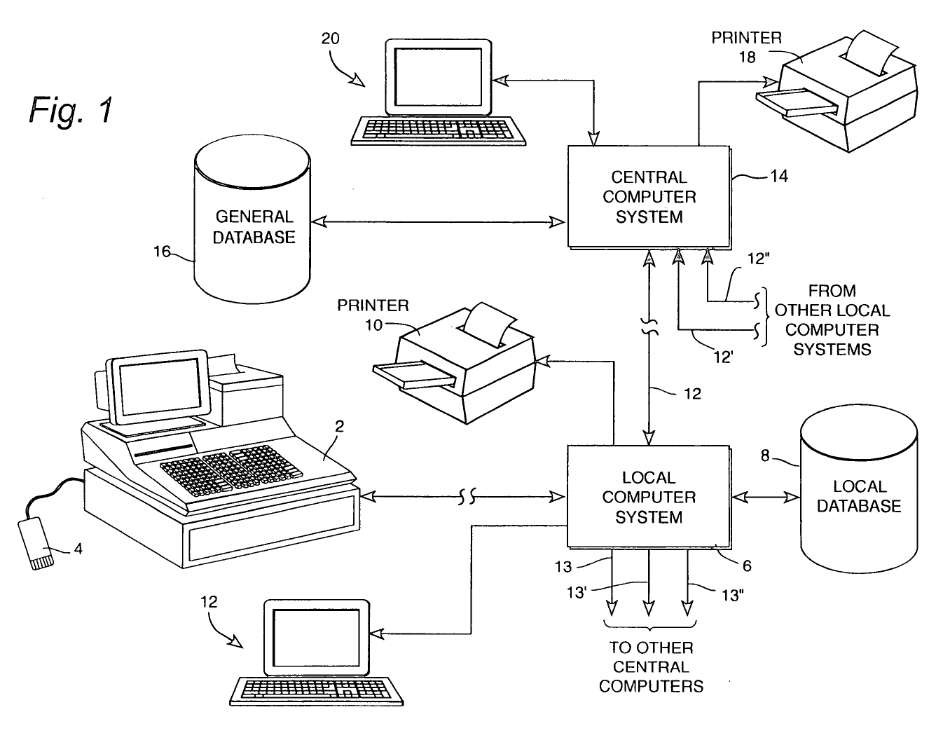

An example of an electronic registration system is illustrated in FIG. 1. Briefly, the example system may include a point of sale register 2 and an associated bar code scanner 4. The register 2 may be connected with a local computer system 6 in a suitable manner. For example, the register 2 may be “hard-wired” to the local computer system 6. Alternatively, the register 2 and the local computer system 6 may communicate, for example, through modems and telephone lines, or over radio communication channels. Any appropriate communication channel may be used.

In certain situations (e.g., single store retailers), the local computer system 6 may be located in proximity to the register 2. For large chain stores, however, the local retailer computer 6 may be situated at a central location with links to the registers 2 at individual stores. The particular arrangement will depend on the preferences and circumstances of the specific retailer.

The local retailer computer system may include an associated local database 8 for storing registration information. Additionally, a local printer 10 and an operator terminal 12 may be provided. The operator terminal may be used, for example, by a store clerk upon return of merchandise to locate pertinent sales information in the local database 8. The printer 10 may be used to produce hard copies of end-of-day sales reports and the like.

In one exemplary illustrative non-limiting implementation, a communication channel 12 is provided between the retailer computer system 6 and a central computer system 14. The central computer system may, for example, be a manufacturer computer system. Alternatively, the central system could, for example, be a regional computer system for a large chain of stores, a distributor computer system, or the like. It should be appreciated that the term communication channel is used herein in its broadest sense, and includes any suitable technique for passing electronic information between systems. Such suitable techniques include, for example, electronic links via modem, radio links, wireless communication, or even communications established by physically transporting a recording medium, such as a magnetic disk, magnetic tape, or optical disk, from one system to the other.

A general database 16 may be associated with the central computer system 14 for storing transaction information from a plurality of retailer computer systems 6. Additionally, a printer 18 and an operator terminal 20 may be included with the central computer system 14.

As illustrated in FIG. 1, the central computer system 14 may have a number of additional communications links 12′, 12″, etc. for receiving information from other local computer systems. Thus, for example, a manufacturer may receive information from a number of different retailers. Additionally, the local computer system 6 may include a number of additional communication channels 13, 13′, 13″, etc. for connecting with other central computer systems. Accordingly, an individual retailer can electronically register products from a number of different manufacturers.

For convenience, the multiple communication channels in FIG. 1 are illustrated with separate lines. It should be noted, however, that separate lines are not necessary. For example, the local computer system 6 more likely would have a single communications line, and connection with the particular central computer system 14 would be made through a modem by dialing the appropriate telephone number.

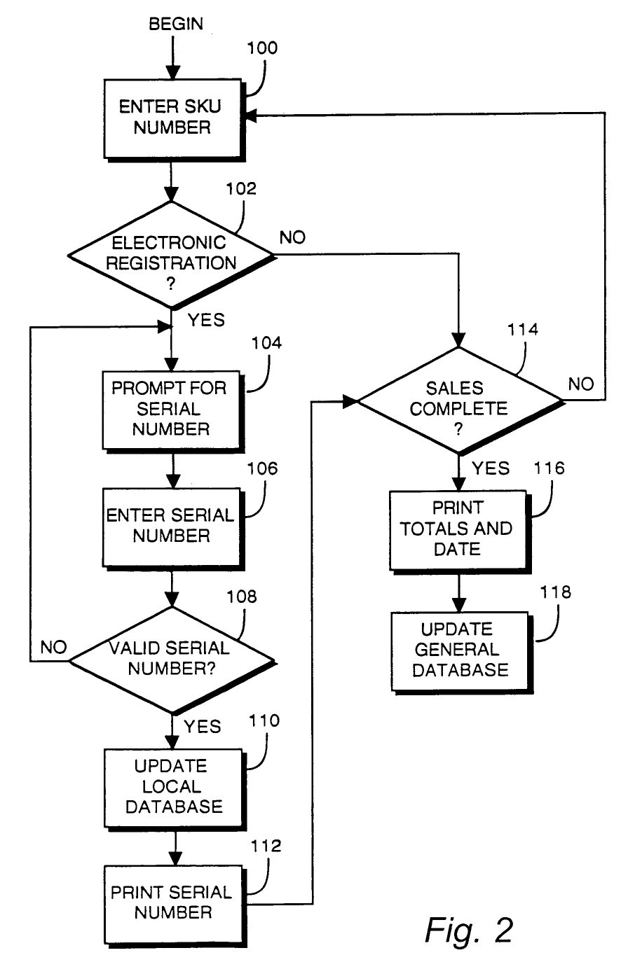

An example of the operation of the system illustrated in FIG. 1 is described in connection with FIGS. 2-4. Referring now to FIG. 2, the electronic registration process begins when a customer brings merchandise to the register for check out. The sales clerk enters the SKU number which identifies the type of product involved in the transaction (e.g., Super Nintendo Entertainment System, Game Boy, Virtual Boy, Nintendo N64, etc.) by, for example, scanning a UPC product code included on the product packaging (100). Of course, key entry or another technique for entering the SKU number may be used.

Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired (102). If so, the store associate is prompted to enter the serial number, or some other unique identifier, of the individual item (104). Possible unique identifiers include, but are not limited to, a combination of a UPC (EAN, JAN) number and/or Brand Name and/or Model number, plus a serial number, or an Electronic Product Code (EPC) provided from a Radio Frequency ID (RFID), etc.

The serial number, or some other unique identifier, may be entered (106), for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as one exemplary form of individual production identification information.

Once the serial number is entered, a check may be made to ensure that the serial number is valid (108). If not, control returns to 104, and the store associate is again prompted to enter the serial number. This is repeated until a valid serial number is obtained. It may be desirable to provide store managers with the ability to override the requirement to enter a serial number in a limited number of situations. If such an ability is given, however, the overrides should be monitored to ensure the ability is not abused. This may be done, for example, by generating a periodic report listing all overrides by individual managers.

Several different techniques may be used to evaluate and verify the validity of the serial number. In one technique, a check digit is added to the serial number. Such a technique may utilize a predetermined mathematical operation performed on the digits of the serial number. If the result of the predetermined mathematical operation is equal to the check digit, the validity of the serial number is verified.

An example of a check digit technique will be described in connection with an eight-digit serial number. A predetermined mathematical operation associated with the check digit may be to multiply the sum of the first four digits of the serial number of by two (2), multiply the sum of the last four digits by three (3), and sum the resulting products. This may be expressed in equation form as:

2(N.sub.1+N.sub.2+N.sub.3+N.sub.4)+3(N.sub.5+N.sub.6+N.sub.7+N.sub.8)

where N.sub.1 is the first digit of the serial number, N.sub.2 is the second digit of the serial number, and so on. The check digit may then be taken as the least significant digit of the result. Thus, for a serial number 22312313, the result of the predetermined mathematical operation is 2*(2+2+3+1)+3*(2+3+1+3)=16+27=43. The check digit is the least significant digit; that is the check digit is 3. Accordingly, the number appearing on the product would be 223123133, wherein the last digit is the check digit. For serial number 10532641, the check digit is 7[2*(1+0+5+3)+3*(2+6+4+1)=18+39=57], and the number appearing on the product would be 105326417.

The particular mathematical operation used in connection with the check digit is not critical. Any predetermined mathematical operation may be used to obtain the check digit. Indeed, for added security, it is possible to utilize more than one check digit, wherein each check digit is calculated by a different mathematical operation. Whatever mathematical operation is used, however, it is desirable to minimize the number of individuals with knowledge of the specific operation to reduce the risk of false serial numbers being generated.

Once the serial number is verified (108), a local database may be updated with the serial number information and any other necessary or desired information (110). This information might include the price paid, the store associate responsible for the sale, the date of the transaction, and the like.

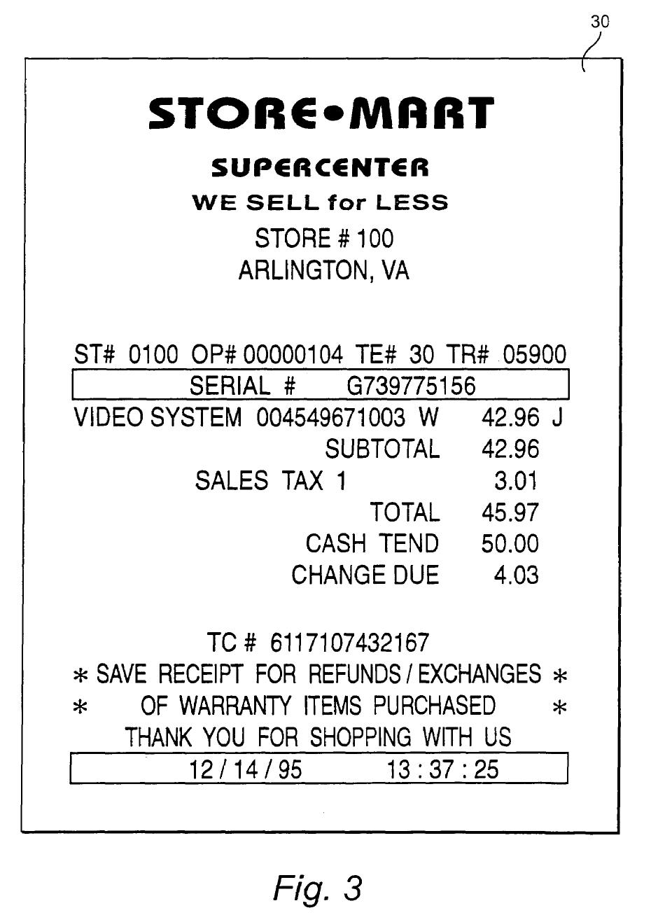

The serial number of the individual product may be printed (112) as part of a written customer transaction receipt. As shown in the sample sales receipt 30 of FIG. 3, the serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction may appear anywhere on the receipt. In the example operation illustrated in FIG. 2 and the sample sales receipt of FIG. 3, the date is printed at the end of the sales receipt 30 (116). For ease of viewing, the serial number and date on the sample receipt 30 are indicated by boxes. If desired, an actual printed receipt may also have such information highlighted, for example, by a different color ink.

Turning back to the example operation illustrated in FIG. 2, after the serial number is printed, a check is made to determine whether sales are complete (114). Ordinarily, this will be based on the store associate hitting a TOTAL button on the cash register. If sales are not complete, control returns to 100 for entry of a SKU number for the next product. Otherwise, sales totals are calculated and printed on the receipt along with the current date (116). Thereafter, the central computer system may be contacted and the general database may be updated.

It should be emphasized that the operation illustrated in FIG. 2 is merely exemplary, and that the steps need not be performed in the particular order shown. For example, all print operations and database updates can take place after sales are completed. Additionally, it is not necessary to update the databases on an item-by-item basis. Indeed, efficiency and speed in updating the general database may be increased by batching transactions in groups of, for example, fifteen transactions.

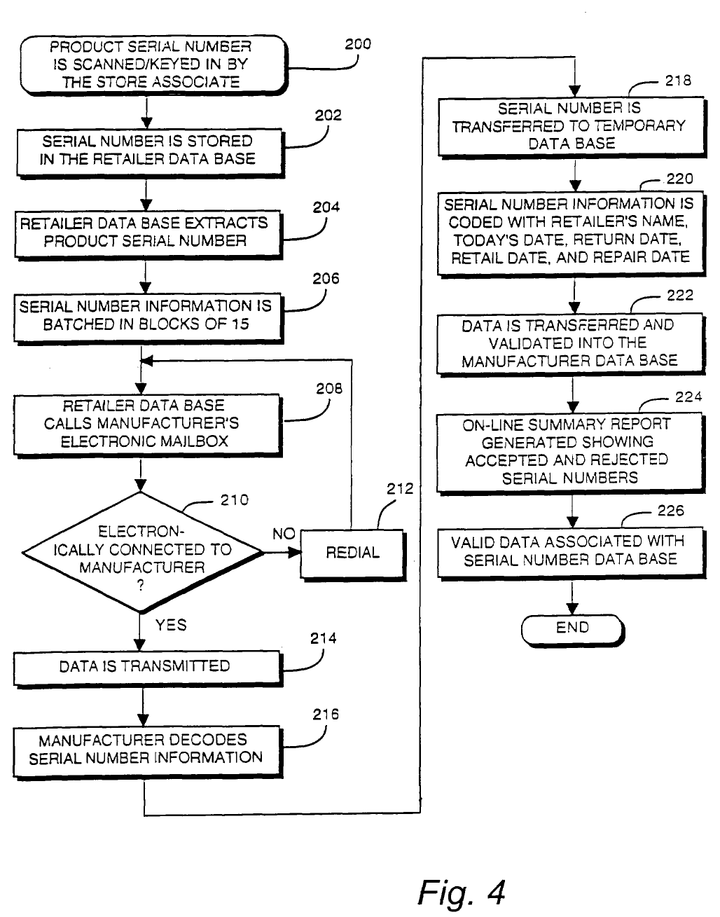

An example technique for interfacing the local computer system 6 to the central computer system 14 is illustrated in FIG. 4. Product serial numbers are scanned or keyed in by a store associate (200) and stored with associated information in the local database (202) using an operation such as discussed in connection with FIG. 2. Thereafter, the local computer system 6 extracts the serial number information from the database (204) and batches the information in blocks of fifteen (206). The operations represented by 204 and 206 may be performed periodically, for example, daily.

Once the serial number information is properly batched (206), the local computer system 6, in this case a retailer system, dials the general computer system 14, in this case a manufacturer's computer system, to make an electronic link to an electronic mailbox set up for that particular retailer (208). A separate electronic mailbox may be set up for each manufacturer account. The connection is tested (210) and, if the connection is not properly established, the retailer computer system 6 redials (212) until a proper connection is established. At that point, data is transmitted (214) to the electronic mailbox. Batching the information increases transmission speed and, therefore, reduces data transmission times.

Data communications between the retailer system and the manufacturer system may use a conventional communications format. For example, the computer systems may be equipped with an EDI Translator capable of using the Standard 140 file format established by the EIA. The Standard 140 file format is specifically designed to extract product registration information. A typical transmission would begin with a Transaction Set Header to indicate the start of a transaction and to assign a control number. This would be followed by a Beginning Segment for Product Registration which indicates the beginning of a product registration transaction set and transmits identifying numbers, dates and times. The identifying numbers may include a Purpose Code to identify the type of registration (e.g., original sale or return to stock) and a Reference Number assigned by the user for the particular transaction. Next, a Name segment is transmitted to identify the user by type of organization, name and identifier code. The identifier code may indicate an organizational entity, a physical location, or an individual.

If desired, additional identifying segments such as an Address Information segment and a Geographic Location segment may be transmitted. The address information might include, for example, a street number and name for the individual store. The geographic location information might include the city name, a state or province code as defined by an appropriate Government agency, a postal code (e.g., a zip code in the United States), and a country code.

Following any desired additional identifying segments, specific item identification information (e.g., serial numbers) may be transmitted along with a textual description of the product if desired. Information identifying the individual store that sold the particular item may be associated with the information for that item. Appropriate dividers would be provided to separate the information for the respective individual items. After the individual item information has been transmitted completely, a Transaction Set Trailer segment may be transmitted to indicate the end of the transaction set and provide the count of transmitted segments.

Returning now to FIG. 4, the manufacturer computer system 14 decodes the serial number information received from the retailer (216). The decoded serial number information may initially be stored in a temporary database (218) and, in this exemplary implementation, the serial number information is encoded with the retailer's name, the registration date, the sale date, the last date on which returns will be accepted, and the last date for warranty repairs (220). The individual serial numbers may then be validated using the check digit technique discussed above, and the data is transferred to the manufacturer's general database (222).

Following validation of the serial numbers, an on-line summary report may be generated which lists all accepted and rejected serial numbers (224). The valid data may then be stored in the manufacturer's national serial number database.

The summary report provided in 224 may provide one tool for the manufacturer to locate trouble spots caused, for instance, by malfunctioning retailer systems or attempted fraud. Additional monitoring reports may also be generated as desired. For example, the serial number pass/fail ratio for all returns by a particular retailer over a given time period may be reported, duplicate serial numbers may be located and listed, previously registered serial numbers may be flagged, and cross-references may be made between the registration date and the date the product was returned to the manufacturer. Such reports can be used by the manufacturer to monitor retailer returns for possible problems or abuse.

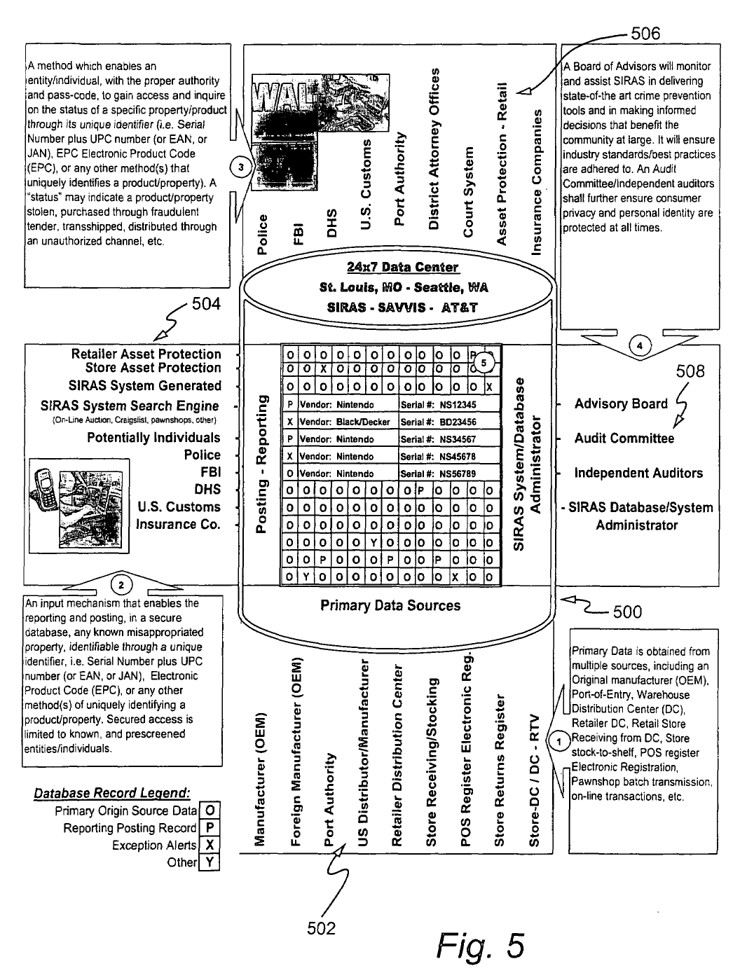

FIG. 5 shows an exemplary illustrative block diagram of a crime prevention database system in which the registration system is employed. The database (500) contains a comprehensive list of all the relevant stored information. Initially, to fill the database (500), multiple sources, such as OEMs, Port Authorities, Distributors, Store Receiving Systems, POS Registration Systems, etc, (502) all are capable of registering the products to the database. For example, if a manufacturer registers the product, the product may, at that point, be flagged as having been shipped from manufacturing. Then the registration may be updated by a distributor, so the product is now flagged as being at that distributor. The same product registration may be updated again upon arrival in the store. With such a comprehensive monitoring system, it is easy to track a product all the way from manufacture to point of sale. This helps aid in inventory loss prevention, and can be useful in other situations, to prove, for example, a chain of possession from manufacturer to retailer. Then, if the product is legitimately sold, its registration can once again be updated in the system and flagged as sold.

If a product is purchased through fraud, such as using a fake or stolen credit card, gift card, debit card, etc., the party who was taken in by the fraud (504) can report the product as “stolen,” “fraud,” or flag the product with some other appropriate identifier. Stores can use this to track missing inventory, and they can then quickly determine if a return is legitimate, or if someone is trying to return stolen goods. Online auction sellers could also use similar asset protection. If someone purchased a good from another, the shipper could register the good before shipment. If the payment never arrived, the shipper could flag the registered good as “stolen” and at least have a means of keep some tabs on the good.

Individuals might also have other uses for the system. If someone lost an expensive cell-phone, watch, PDA, etc. and had pre-registered the device, then they could easily update the status of that product as missing/stolen/lost. If the product later turned up (e.g. someone tried to activate the phone, or sell the watch in a pawn shop), the proper owner could be informed.

Other parties which may wish to register and update registries of goods include, but are not limited to, police, FBI, DHS, U.S. Customs, insurance companies, etc.

In addition to registering products and changing the registration status, parties (506) could also be interested in running queries on a database to check the status of particular goods. This has obvious use to law enforcement. If the police raid a suspected criminal's house and find nine TVs, they can quickly query the database to see if any retailers or consumers have reported those serial numbers as stolen. They can also flag the registrations for the TVs with some indicia that the TVs are in police custody, so that if someone later reports one as having been stolen, the person knows where to retrieve the TV.

Stores can also report inventory as stolen, fraudulently purchased, etc. If someone brings a product back for a return, and it is flagged as being associated with fraud or theft, the store can make a decision as to whether or not to contact security or law enforcement. Also, if the product is still flagged as being on the shelf, the store can quickly know that someone has simply taken a product from the shelf and is trying to return it. In an implementation where the system is capable of being accessed at the point of return, there is little delay in which a criminal may escape or a busy sales associate may inadvertently accept a bad return.

Customs and Port Authorities could scan high price goods to check that those goods were not registered as stolen. This scan could also update the status of the goods so that they showed as having entered the country at a certain location. Pawn shops could check products before purchasing, to ensure they are not buying stolen goods. Insurance companies could require registration of expensive goods, and then check to make sure those goods hadn't transferred to another owner if the goods were reported as destroyed or stolen. Insurance companies could also use the system to attempt to recover any goods that were reported as stolen.

Additionally, access for reporting, updating and checking the database may be limited to authorized users, to ensure that records are not compromised. Security for various levels can depend on the needs of the particular system and the class of user allowed to access a facet of the system. Further, it may be desirable to allow people checking the system for the information associated with a particular ID to peruse the entire system, since they may not know which section/manufacturer/retailer/etc. under which the item is located. On the other hand, if a manufacturer, such as Nintendo, wishes to register products, they may only be able to register, update and modify entries for Nintendo. Their access to other manufacturer's sections may be precluded. It may also be desirable to prescreen entities before giving access to any/all sections.

Numerous other entities and uses exist for this system, those listed herein are given as examples only.

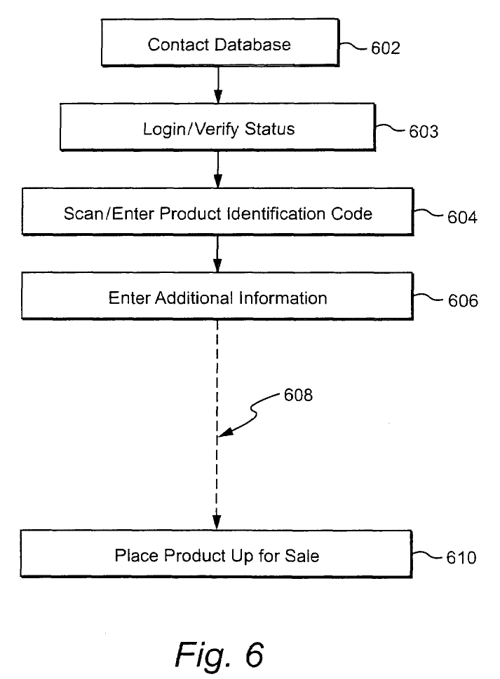

FIG. 6 shows an exemplary registration process for initial registration of the good. According to this exemplary illustrative non-limiting implementation, at some point from manufacture to retail, the database is first contacted (602). After the entity contacting the database has established that they are authorized for a registration transaction (603), they enter a unique ID code associated with the particular produce (604). This can be a serial number, or a combination of some more generic number like a UPC plus another unique identifier. Any code/combination which will uniquely identify the product will suffice. This code can be scanned in, hand-entered, or input through any suitable means.

The entity is then given the option to enter additional information (606). For example, if the manufacturer did the initial registration, then the additional information might consist of a manufacturer's name, location, and, if known, the distributor/retailer to which the product was headed. Similar and/or additional information can be added at a distributor, retail, or any other level at which the product is registered.

Then, a series of transfers/updates may or may not occur (608) before the product is placed onto a shelf for sale (610). For example, the product status may be updated at a distributor and when it arrives at a retailer. These updates might consist of each possessor between the manufacturer and the retailer performing steps 602, 603, 604, and/or 606. Additional suitable actions could also be taken.

With status that is updated each step, it is easy for a product's last known whereabouts to be identified if the product ends up missing. If the product passed, for example, through two distribution centers and a regional HQ without being updated before arriving at the store, and was later determined to be missing, then it might be hard to track down. A distribution chain which regularly used updates at each step would show exactly where an update last did not occur, and thus narrow down the area of loss to a particular transfer or location.

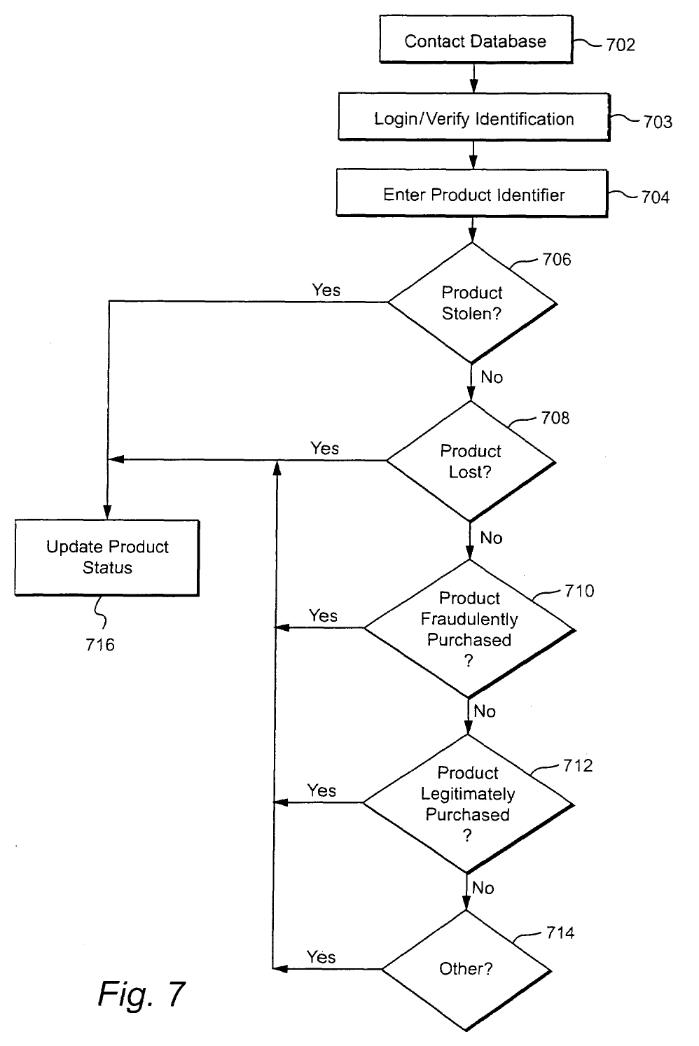

FIG. 7 shows and exemplary access flow for a product database if the status of a product is entered or changed. Again the reporting entity must first contact the database (702) and gain authorization to access the record updates (703). The entity must then input some sort of product identifier (704). Since a product may be lost or stolen, this may not always be the same base identifier stored with the product. For example, if the product was stolen, then the store may provide information such as date of delivery, UPC codes of similar products, last known date in inventory, etc. If the database system searched UPC codes and found ten entries, three of which correlated to legitimately sold goods, and seven which were supposed to still be in inventory, then the store could determine the serial numbers of the stolen product(s) based on the numbers remaining. If only five were left on the shelves, then the two serial numbers not correlating to one of the five remaining products could be flagged as stolen. Other indicia could be used as well to narrow down the ID of a missing product, such as color or other identifying characteristics of the product (e.g. if the store originally had three blue recliners, and now only has two blue recliners).

Or, for example, if a fraudulent purchase was discovered, then the serial number associated with that purchase (initially flagged as a legitimate purchase) could be switched to indicate a fraudulent purchase. If a box is discovered as open and empty, the store may use the UPC or some other identifying method to flag the product as lost or missing. If the product is later discovered, repackaged and sold, then the lost or missing status may be updated at the point of sale to reflect a legitimate sale of that item.

Once the product has been identified in some fashion, the entity reports whether the product was stolen (706), lost (708), fraudulently purchase (710), legitimately purchased (712) or some other (714) status update. The product status is then updated (716). It may be desirable to allow the most recent update to overwrite any previous “present status” indicator for a product. The database can keep a list of all phases of status for a product, but if a quick check is needed then the present status should probably correspond to the most recent update. For example, a product seemingly legitimately purchased may only later be discovered as a fraudulent purchase, and it would be desirable to have the fraudulent purchase flag be the presently associated status. Or a missing item flagged as such may be discovered and sold, then the presently associated status should be that of a legitimate purchase. Additionally, if consumers as well as retailers used the database, then a consumer reporting a good as stolen would want that to be the status, as opposed to the legitimate sale status provided when the consumer first purchased the good. As long as reasonable security measures are taken, criminals should not be able to mislabel the present status of goods in order to aid in perpetration of a crime. It may also, however, be desirable to maintain a record of all status flags associated with a particular item, so that backgrounds of items and possession histories of items can be established if need be.

The steps presented in this and other examples do not necessarily need to be performed in the order presented herein, but are merely shown in such form for exemplary purposes. Nor are all steps necessary, nor is the list of steps exhaustive. This and other flowcharts merely show one exemplary procedure for performing the described process.

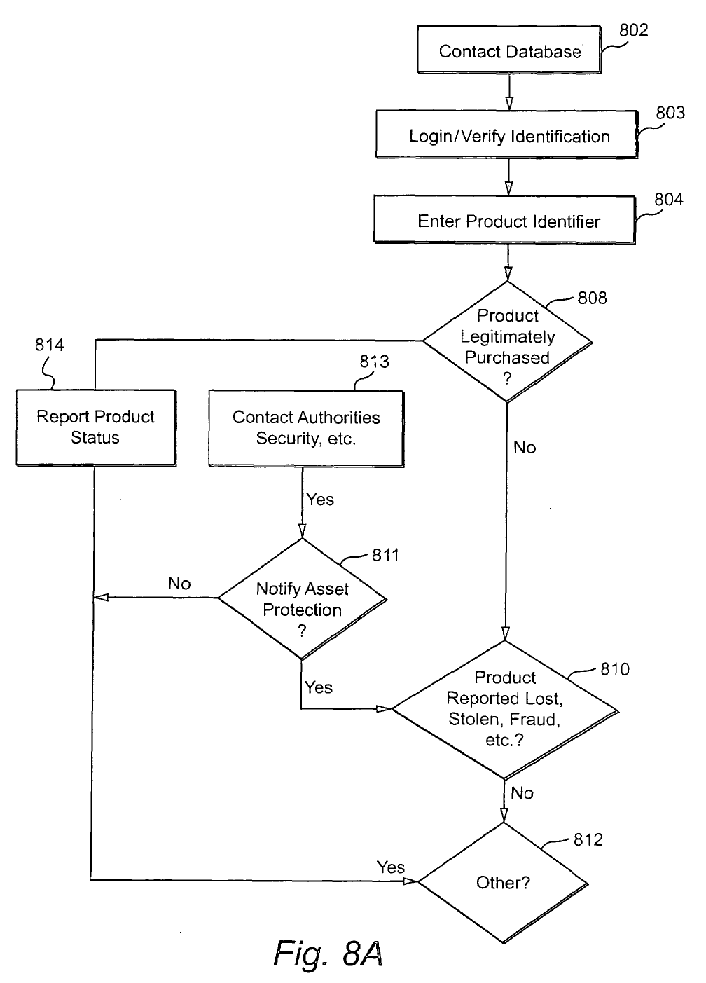

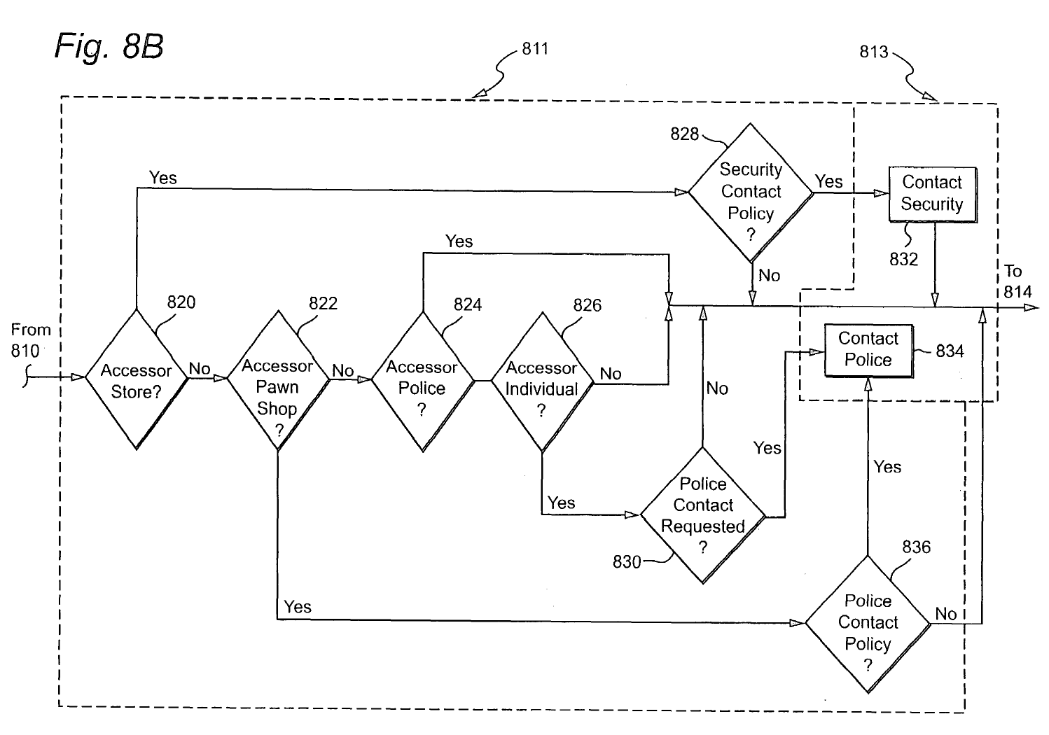

FIG. 8A shows an example of a database access made by an entity checking the present status of goods. As before, the checking entity must first contact the database (802) and establish a right to access the contents (803). Then, the checking entity enters a unique ID code associated with the product (804). Presumably, in this instance, the checking entity would know the ID code because in the checking situations the product would typically be on hand. For example, this could be police checking some allegedly stolen goods, a pawn shop checking to see if goods were stolen before purchase, or a store checking the status of a return.

Even though the above examples of checking entities involve retail/government, there is consumer application for the checking as well. If a product was for sale on, for example, an online auction site, then a seller could post a picture of the serial number. Possible buyers could then access the database to determine that the product was not stolen. The website might even require registration to cut down on customer dissatisfaction and/or incidences of stolen goods changing hands. For example, a website may require a seller to key in an identifier before listing a good. The website can then check the database, and as long as the good is legally possessed, allow the good to be listed.

Certain states also require pawn shops to register goods. Pawn shops could use the database as an easy way to register and check the status of all goods which they handle.

Even courts could benefit from the database. If a defendant claims to own an item alleged to be stolen, the court could compare purchase evidence presented by the defendant with the actual information stored in the database.

All these examples of potential uses are merely exemplary, and are not intended to limit the invention in any way.

Once the checking entity has identified the product to be checked, the system checks if the product was legitimately purchased (808), reported stolen, lost, fraudulently procured, etc. (810), or has any other associated status (812). The present status of the product is then reported back to the checking entity (814). In this exemplary implementation, if the status of lost/stolen/fraudulently procured comes up, then a check is made to see if some form of asset protection should be contacted (811). If so, then the proper authorities are contacted (813) and the checker is notified of the product status.

FIG. 8B shows an exemplary process for notifying asset protection under the exemplary system shown in FIG. 8A. It may be desirable to base a notification policy on the particular entity checking the database. For example, stores may want security called, pawnshops may want (or be required) to have the police called, and the police may not want anyone called. In this exemplary illustrative non-limiting implementation, the system checks to see if the accessor is a store (820), a pawn shop (822), the police (824), or an individual (826). Such a check can be performed based on the accessor's ID or any other suitable criteria.

If the accessor was a store, then there may be an additional check to see if the store automatically calls security (828). For example, some stores may wish to implement a backup system, or rescan an item, before having security come forward and arrest the individual. Other stores may want security called instantly (832).

If the accessor was a pawnshop, the system similarly checks to see if police should be immediately contacted (836). Perhaps a state would require immediate contact of the police if a stolen item was scanned by a pawn shop. This can also potentially be a safe way for a pawn shop owner to contact the police without any overt action to notify a criminal. If the police need to be contacted, the system can contact them (834).

On the other hand, if police are the ones accessing the system, then they don't need to have the system place another call to the police, as they already know about the particular item for which they have called.

Individuals may be given an option to contact the police (830). For example, if someone buys an item from another person online and attempts to register it and finds out it was stolen, they may be asked if they wish to contact the authorities (830). If they select yes, then the system can contact the police (834).

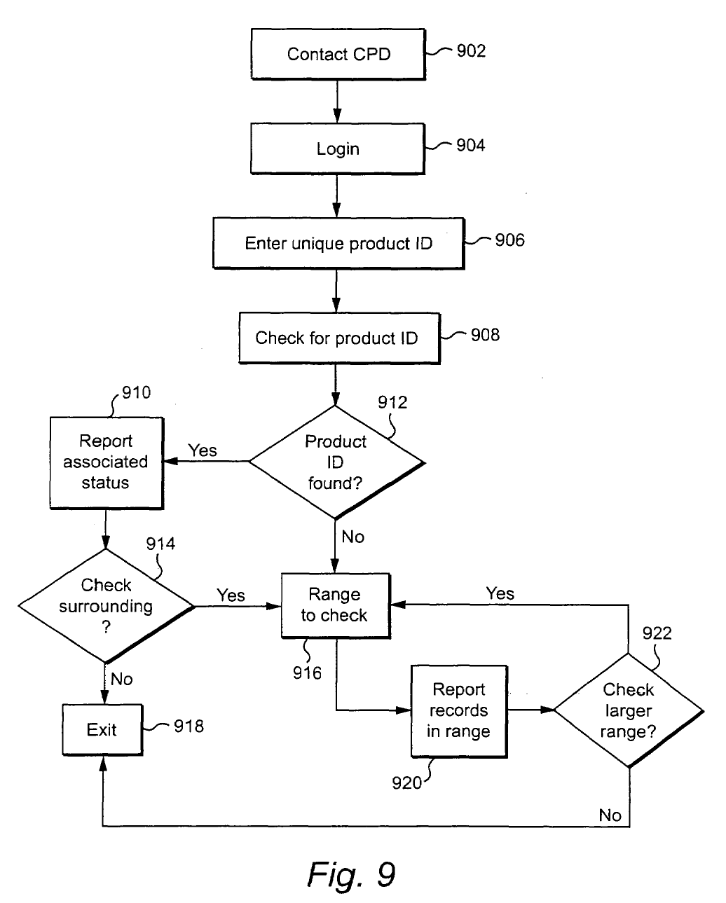

FIG. 9 shows another exemplary illustrative non-limiting use for the CPD. In the exemplary process of FIG. 9, the CPD is used to check the serial numbers surrounding a number corresponding to an item recovered by the police.

As before, the accessor contacts the CPD (902) and enters some verification information to login (904). Next, the accessor enters a unique product ID associated with the item in question (906). In the example associated with this exemplary process, the police would possibly be the police. They could access the database, and input the serial number associated with a product which they had just recovered from a thief.

Next, the database will check for a product corresponding to the entered ID (908). Depending on when or if a particular product was registered, it may or may not have some status associated with it. For example, if the manufacturer registered the products, then the database may have that registration, even if the store seeking to recover the product never registered the product.

The exemplary process then branches based on whether or not a product ID was found (912). If there is a corresponding ID, then the status associated with the particular product is reported back (910). If there is not a corresponding ID, then the accessor is asked to provide a range to check (916). In this exemplary implementation, the range is a number of products on either side of the stored serial number. Other criteria could also be used for the search.

Even if there is an associated status with the input serial number or other unique ID, the accessor still may want to do a range check. Consequently, the system, after reporting any found associated status (910), asks if the accessor would like to do a range check (914). If not, the program may exit (918).

One example of a situation in which a range check may still be desired, even if there is an associated status, is as follows: If a manufacturer such as, for example, Nintendo, registered all products at point of sale to distributors, then there might be an associated status corresponding to the fact that Nintendo sold the product. But, it may not indicate to whom the product was sold. In this case, a check would still be desired to try and determine to whom the particular product was sold.

After the accessor inputs a check range (916), the database reports back all serial numbers in that range and an associated status (920). For example, if a Nintendo DS were recovered and had a serial number of aa12300011, then a range of three might produce the following exemplary results:

| | |
|---|---|
| aa12300008 | Store X |
| aa12300009 | Store X |
| aa12300010 | Store X |
| aa12300011 | not found |
| aa12300012 | Store X |
| aa12300013 | Store X |
| aa12300014 | Store X |

This would show, with a high degree of probability, that the recovered product belonged to Store X.

If a larger range report is desired, the accessor can answer “yes” to the check larger range inquiry (922). At that point, the range entry (916) and reporting (920) steps would be repeated. If there was no desire to check a larger range, the process could exit (918).

The exemplary CPD can sort based on product type and then organize the serial numbers in order, making it able to recover a range of recorded serial numbers on either side of the product. Further, since many manufacturers palletize their products as they come off of the line, the serial numbers on a shipped palette are usually in numeric order. Thus, if a merchant buys a palette of goods, they will typically take possession of a set of sequentially numbered products.

The CPD of certain exemplary embodiments allows a product to be linked to a specific event. It will be appreciated that the event may be a crime, a person misplacing or losing the product, a product not being delivered or being misdelivered to a person or retailer, etc. This illustrative feature of the CPD advantageously enables a closed-loop system to be created, wherein the users are protected and one end, and law enforcement or other authorized personnel have visibility at the other end. It will be appreciated that users of the CPD may include, for example, manufacturers, retailers, customers, credit-card companies, insurance companies, law enforcement personnel, retail asset protection investigators, etc.

More particularly, in a first example implementation, a user can tag an item as stolen or missing in the CPD. If the user later finds the product (e.g., in the event that the product simply was misplaced and subsequently found by or otherwise returned to the user), the user can then “unflag” the product in the CPD. If, however, the item is flagged as stolen or missing and it is later discovered at a place where it should not be (e.g., in the event that it is found, confiscated, or otherwise obtained by the police, given to a pawnbroker, etc.), an the CPD can identify the product as having been lost or stolen and sometimes may even provide a lead to the rightful owner.

In a second example implementation, the CPD may help to detect that a product is missing before a retailer even recognizes it as missing, e.g., from a shipment from a manufacturer, from its shelves, etc. In the event that the product is misdelivered or stolen such that it never makes it into the retailer's store, or in the event that the product goes missing from the retailer without the retailer noticing, the product may be “found” before a protected user even knows to be on the lookout for the missing product. This functionality may be accomplished in certain exemplary embodiments by adding products to the CPD when the are shipped from the manufacturer to the retailer. For example, the CPD may be cross-referenced to determine if the product was ever “originally sold” from the retailer prior to a “resale,” e.g., at a pawnshop, auction house, or other location (which may even include another retail shop).

In certain exemplary embodiments a fraud reduction and product recovery system is provided. A database includes a plurality of product entries, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. Product checking programmed logic circuitry is configured to determine whether the product to be checked was legitimately acquired. The second interface is further configured to provide an indication to the second authorized user whether the product was legitimately acquired.

Each status identifier may indicate, for example, at least whether the associated product has been lost or stolen. Additionally or alternatively, each product entry may further include for example, first sale date, anticipated first sale location, actual first sale location, and/or other like fields. Additionally or alternatively, each product entry may further include an owner contact field that includes contact information for an owner of the product.

The first authorized user may be, for example, a manufacturer, retailer, customer, etc., whereas the second authorized user may be, for example, a person charged with law enforcement, a retail asset protection investigator, an auction house employee, a pawnshop employee, etc. The first interface may be accessible the first authorized user at a location remote from the database such as, for example, at a point-of-sale or via a home computer.

The checking programmed logic circuitry may be further configured to indicate whether the product to be checked was legitimately acquired by determining whether the first sale date field is prior to a date of an attempted purchase, by comparing the actual first sale location field to the anticipated first sale location field, etc.

Notifying programmed logic circuitry may be configured to notify law enforcement personnel when the checking programmed logic circuitry indicates that the product to be checked was not, or may not have been, legitimately acquired. Additionally or alternatively, notifying programmed logic circuitry may be configured to contact the owner of the product to be checked when the checking programmed logic circuitry indicates that the product to be checked was not, or may not have been, legitimately acquired.

The interfaces to the database may be, for example, computer-implemented user interfaces. In certain exemplary embodiments, the user interfaces may be provided through custom applications running locally on a computer with a suitable network connection, webpages accessible over a network (e.g., such as the Internet), etc. In certain exemplary embodiments, the interfaces may be at least partially automatically accessed. That is, in certain exemplary embodiments, the first interface may be automatically accessed and the database may be updated, e.g., when a customer purchases a product at a point-of-sale location or online. In such cases, information about the product (e.g., brand name, UPC or EPC, date or purchase, place of purchase, etc.) as well as information about the purchaser (e.g., name, contact information, etc.) may be gathered and stored to the database, e.g., by reading information about the product from a register and information about the purchaser from credit card information, from online forms, etc. In certain exemplary embodiments, the second interface may be automatically accessed, e.g., when a product is loaded for sale or actually sold by an online auction house, received or sold at a pawnshop, etc. Notifications or alerts may be generated to interrupt (e.g., place a temporary hold on or completely stop) a prospective sale.

In certain exemplary embodiments, in a fraud reduction and product recovery system, a method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

In certain exemplary embodiments, a computer-readable storage medium tangibly storing instructions for causing a computer to implement a fraud reduction and product recovery method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

While the invention has been described in connection with exemplary illustrative non-limiting implementations, it is to be understood that the invention is not to be limited to the disclosed implementations, but on the contrary, is intended to cover various modifications and equivalent arrangements included within the spirit and scope of the appended claims.

What is claimed is:

1. A fraud reduction and product recovery system, comprising:
a database including a plurality of product entries, each product entry having at least a status field associated therewith;
a first interface to the database configured to enable a first authorized user to add product entries and/or change the status identifiers of the product entries;
a second interface to the database configured to enable a second authorized user to input information regarding a product to be checked against the database to determine whether it was legitimately acquired; and
product checking programmed logic circuitry configured to determine whether the product to be checked was legitimately acquired,
wherein the second interface is further configured to provide an indication to the second authorized user whether the product was legitimately acquired.

2. The system of claim 1, wherein each said status identifier indicates at least whether the associated product has been lost or stolen.

3. The system of claim 1, wherein the first authorized user is a manufacturer, retailer, or customer.

4. The system of claim 1, wherein the second authorized user is a person charged with law enforcement or a retail asset protection investigator.

5. The system of claim 1, wherein the second authorized user is an auction house employee or a pawnshop employee.

6. The system of claim 1, wherein the first interface is accessible the first authorized user at a location remote from the database.

7. The system of claim 6, wherein the first interface is accessible by the first authorized user at a point-of-sale or via a home computer.

8. The system of claim 1, wherein each said product entry further includes first sale date, anticipated first sale location, and actual first sale location fields associated therewith.

9. The system of claim 8, wherein the checking programmed logic circuitry is further configured to indicate whether the product to be checked was legitimately acquired by determining whether the first sale date field is prior to a date of an attempted purchase.

10. The system of claim 8, wherein the checking programmed logic circuitry is further configured to indicate whether the product to be checked was legitimately acquired by comparing the actual first sale location field to the anticipated first sale location field.

11. The system of claim 1, further comprising notifying programmed logic circuitry configured to notify law enforcement personnel when the checking programmed logic circuitry indicates that the product to be checked was not, or may not have been, legitimately acquired.

12. The system of claim 1, wherein each said product entry further includes an owner contact field that includes contact information for an owner of the product.

13. The system of claim 12, further comprising notifying programmed logic circuitry configured to contact the owner of the product to be checked when the checking programmed logic circuitry indicates that the product to be checked was not, or may not have been, legitimately acquired.

14. In a fraud reduction and product recovery system, a method comprising:
maintaining a database including a plurality of product entries, each product entry having at least a status field associated therewith;
providing a first interface to the database configured to enable a first authorized user to add product entries and/or change the status identifiers of the product entries;
providing a second interface to the database configured to enable a second authorized user to input information regarding a product to be checked against the database to determine whether it was legitimately acquired; and
determining whether the product to be checked was legitimately acquired,
wherein the second interface is further configured to provide an indication to the second authorized user whether the product was legitimately acquired.

15. The method of claim 14, wherein each said status identifier indicates at least whether the associated product has been lost or stolen.

16. The method of claim 14, further comprising determining whether the product to be checked was legitimately acquired by comparing a first sale date field associated with the product to be checked with a date of an attempted purchase.

17. The method of claim 14, further comprising determining whether the product to be checked was legitimately acquired by comparing an actual first sale location field associated with the product to be checked to an anticipated first sale location field of the product to be checked.

18. The method of claim 14, further comprising notifying law enforcement personnel when the product to be checked was not, or may not have been, legitimately acquired.

19. The method of claim 14, further comprising notifying a true owner of the product to be checked when the checking programmed logic circuitry indicates that the product to be checked was not, or may not have been, legitimately acquired.

20. A computer-readable storage medium tangibly storing instructions for causing a computer to implement a fraud reduction and product recovery method, the method comprising:
maintaining a database including a plurality of product entries, each product entry having at least a status field associated therewith;
providing a first interface to the database configured to enable a first authorized user to add product entries and/or change the status identifiers of the product entries;
providing a second interface to the database configured to enable a second authorized user to input information regarding a product to be checked against the database to determine whether it was legitimately acquired; and
determining whether the product to be checked was legitimately acquired,
wherein the second interface is further configured to provide an indication to the second authorized user whether the product was legitimately acquired.
